(19) United States
(12) Patent Application Publication
(10) Pub. No.: US 2026/0342921 A1
(43) Pub. Date: Oct. 29, 2026

(54) IMAGE PROCESSING APPARATUS AND METHOD FOR CONTROLLING IMAGE PROCESSING APPARATUS

(71) Applicant: KYOCERA Document Solutions Inc., Osaka (JP)

(72) Inventors: Masaru Ono, Osaka (JP); Yasuyuki Yabuuchi, Osaka (JP)

(21) Appl. No.: 19/655,125

(22) Filed: Apr. 22, 2026

(30) Foreign Application Priority Data
Apr. 23, 2025 (JP) 2025-071053

(51) Int. Cl. H04N 1/00

(52) U.S. Cl. CPC H04N 1/0009; H04N 1/00005; H04N 1/00074; H04N 1/00087; H04N 2201/0094

(57) ABSTRACT

An image processing apparatus includes a detection processing portion and a memory processing portion. The detection processing portion detects a plurality of types of abnormalities in an image process including at least one of a reading process of reading an image from a document sheet and a formation process of forming the image on a sheet. The memory processing portion stores detection results of the plurality of types of abnormalities in a memory as one variable.

### INCORPORATION BY REFERENCE

This application is based upon and claims the benefit of priority from the corresponding Japanese Patent Application No. 2025-071053 filed on Apr. 23, 2025, the entire contents of which are incorporated herein by reference.

### BACKGROUND

This disclosure relates to an image processing apparatus and a method for controlling an image processing apparatus.

An image processing apparatus that senses a multi-feed in which a plurality of sheets is conveyed in an overlapped state has been known as related art.

### SUMMARY

An image processing apparatus according to an aspect of this disclosure includes a detection processing portion and a memory processing portion. The detection processing portion detects a plurality of types of abnormalities in an image process including at least one of a reading process of reading an image from a document sheet and a formation process of forming the image on a sheet. The memory processing portion stores detection results of the plurality of types of abnormalities in a memory as one variable.

A method for controlling an image processing apparatus according to another aspect of this disclosure includes detecting a plurality of types of abnormalities in an image process including at least one of a reading process of reading an image from a document sheet and a formation process of forming the image on a sheet. The method for controlling the image processing apparatus includes storing detection results of the plurality of types of abnormalities in a memory as one variable.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic block diagram showing a configuration of an image processing apparatus according to an embodiment.

FIG. 2 is a schematic diagram showing external appearance of the image processing apparatus according to the embodiment.

FIG. 3 is a schematic diagram showing an example in which each of detection results of a plurality of types of abnormalities is stored in a memory in an image processing apparatus according to a comparative example.

FIG. 4 is a schematic diagram showing an example in which each of detection results of a plurality of types of abnormalities is stored in a memory in the image processing apparatus according to the embodiment.

FIG. 5 is a schematic diagram showing an example of one variable in the image processing apparatus according to the embodiment.

FIG. 6 is a flowchart showing an operation example of the image processing apparatus according to the embodiment.

### DETAILED DESCRIPTION

Hereinafter, an embodiment of this disclosure will be described with reference to the accompanying drawings. The following embodiment is a specific example of this disclosure and does not intend to limit the technical scope of this disclosure.

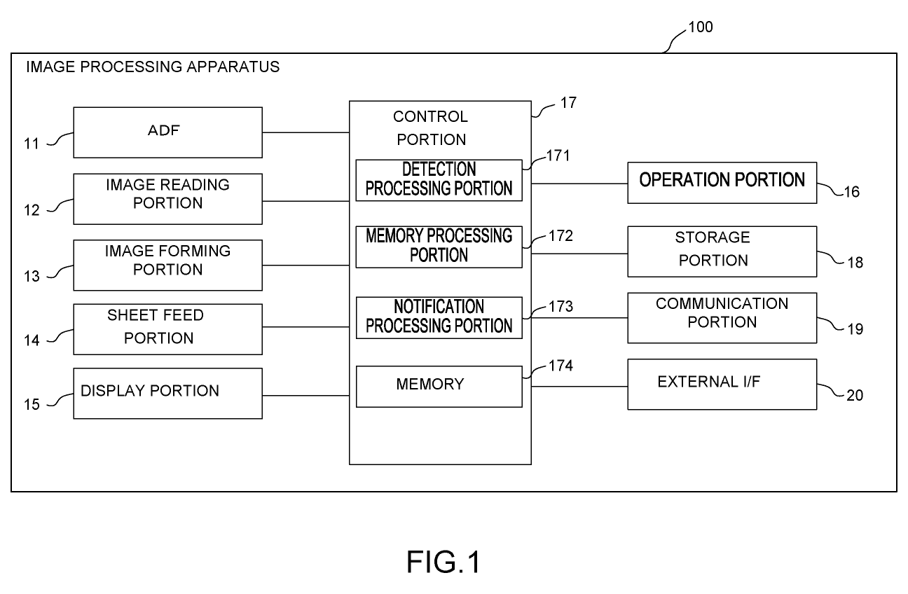

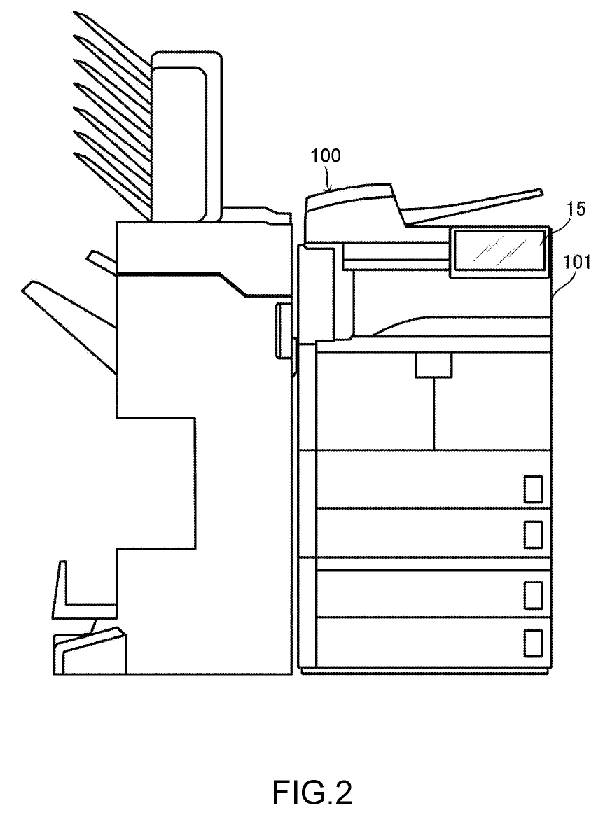

1. Overall Configuration of Image Processing Apparatus
First, the overall configuration of an image processing apparatus 100 according to this embodiment will be described with reference to FIGS. 1 and 2.

As an example, the image processing apparatus 100 according to this embodiment is a multifunction peripheral having a plurality of functions such as a scan function of acquiring image data from a document sheet, a print function of forming an image on the basis of the image data, a facsimile function, and a copy function. It is sufficient if the image processing apparatus 100 has an image processing function including at least one of the function of forming an image and the function of acquiring image data. The image processing apparatus 100 may be a printer, a scanner, a facsimile apparatus, a copier, and the like.

As shown in FIG. 1, the image processing apparatus 100 includes an automatic document sheet conveying device 11, an image reading portion 12, an image forming portion 13, a sheet feed portion 14, a display portion 15, an operation portion 16, a control portion 17, a storage portion 18, a communication portion 19, and an external interface 20. The automatic document sheet conveying device 11 is an auto document feeder (ADF). The automatic document sheet conveying device 11 is thus described as an "ADF" in FIG. 1 and will also be referred to as the "ADF 11" in the following description. In addition, the external interface 20 is an external interface (I/F). The external interface 20 is thus described as an "external I/F" in FIG. 1 and will also be referred to as the "external I/F 20" in the following description.

In this embodiment, the image processing apparatus 100 includes a body 101 as shown in FIG. 2. The ADF 11, the image reading portion 12, the image forming portion 13, the sheet feed portion 14, the display portion 15, the operation portion 16, the control portion 17, the storage portion 18, the communication portion 19, and the external I/F 20 are all provided in the body 101.

The ADF 11 conveys a document sheet an image on which is read by the image reading portion 12. The ADF 11 includes a document sheet set portion, a plurality of conveying rollers, a document sheet holder, a sheet discharge portion, and the like.

The image reading portion 12 reads an image from a document sheet and outputs image data corresponding to the read image. The image reading portion 12 includes a document sheet table, a light source, a plurality of mirrors, an optical lens, a charge coupled device (CCD), and the like.

The image forming portion 13 forms an image on a sheet in an electrophotographic scheme on the basis of image data output from the image reading portion 12. In addition, the image forming portion 13 forms an image on a sheet on the basis of image data received from an information processing apparatus such as a personal computer outside the image processing apparatus 100. The image forming portion 13 includes four image forming units corresponding to the four colors of C (cyan), M (magenta), Y (yellow), and K (black), a laser scanning unit, an intermediate transfer belt, a secondary transfer roller, a fixing device, and the like. For example, the image forming portion 13 may be configured to form an image on a sheet in an image forming scheme such as an inkjet scheme other than the electrophotographic scheme.

The image forming portion 13 forms an image on a sheet using toner serving as developer. In a case where the image forming portion 13 forms an image in an inkjet scheme, ink (another example of the developer) is supplied instead of toner. Examples of the toner supplied to the image forming portion 13 include toners for the plurality of colors of C (cyan), M (magenta), Y (yellow), and K (black). The sheet having an image formed thereon by the image forming portion 13 is discharged (supplied) to an extension device or the like for a post-process.

The sheet feed portion 14 supplies a sheet to the image forming portion 13. The sheet feed portion 14 includes a sheet feed cassette, a manual feed tray, a sheet conveyance path, a plurality of conveying rollers, and the like. The image forming portion 13 forms an image on a sheet supplied from the sheet feed portion 14. The sheet supplied to the image forming portion 13 is paper as an example, but is not limited to paper. For example, the sheet supplied to the image forming portion 13 may be a resin film or the like.

The display portion 15 is a user interface that presents (displays) information to a user in the image processing apparatus 100. The display portion 15 displays various kinds of information in accordance with a control instruction from the control portion 17. In this embodiment, as an example, the display portion 15 includes a liquid-crystal display and displays, on the liquid-crystal display, a display screen including various kinds of information.

The operation portion 16 is, for example, a user interface that receives an operation performed by a user on the display screen displayed on the display portion 15. The operation portion 16 outputs, for example, electrical signals corresponding to operations of the user, thereby receiving various operations made by the user. In this embodiment, as an example, the operation portion 16 includes a switch, a key or a numeric keypad, a touch panel, and the like.

In addition, the image processing apparatus 100 may include, for example, a sound output portion, a sound input portion, and the like as user interfaces in addition to or instead of the display portion 15 and the operation portion 16.

The control portion 17 includes, as a main component, a computer system including one or more processors and one or more memories and centrally controls the image processing apparatus 100. In the image processing apparatus 100, the one or more processors execute a program, thereby implementing a function of the control portion 17. In this embodiment, as an example, the control portion 17 includes a central processing unit (CPU).

The program may be recorded in advance in the one or more memories, provided through an electric communication line such as the Internet, or recorded and provided in a non-transitory recording medium such as a memory card or an optical disc readable to the computer system. The one or more processors each include one or more electronic circuits including a semiconductor integrated circuit. Furthermore, the computer system here includes a microcontroller including one or more processors and one or more memories. The control portion 17 may be a control portion provided separately from a main control portion that centrally controls the image processing apparatus 100.

Information about a control program or the like for causing the control portion 17 to execute various processes is stored in the storage portion 18 in advance. In this embodiment, the storage portion 18 includes, for example, one or more non-volatile memories such as a read only memory (ROM), a hard disk (HDD), or a solid state disk (SSD). In addition, the storage portion 18 may include, for example, one or more volatile memories such as a random access memory (RAM).

The communication portion 19 is an interface that executes data communication with an external system connected to the image processing apparatus 100, for example, through a communication network such as the Internet or a local area network (LAN). The data communication may be wired communication or wireless communication. In addition, the data communication may be, for example, wireless communication compliant with a short-range wireless communication standard such as NFC (Near Field Communication) (registered trademark) or Bluetooth (registered trademark).

The external I/F 20 is an interface that has a port to which an external memory or an external apparatus is connected and executes data communication with the external memory or the external apparatus connected to the port. In this embodiment, the external memory includes, for example, a universal serial bus (USB) memory. In addition, the external apparatus includes, for example, a device supporting USB mass storage.

Incidentally, an image processing apparatus that senses a multi-feed in which a plurality of sheets is conveyed in an overlapped state has been known as related art.

An image processing apparatus as in the related art described above has a function of detecting, for example, a plurality of types of abnormalities such as a multi-feed and a defect in an image read from a document sheet in some cases. In this case, it is desirable to reduce the usage rate of a memory for storing detection results of the plurality of types of abnormalities in the memory.

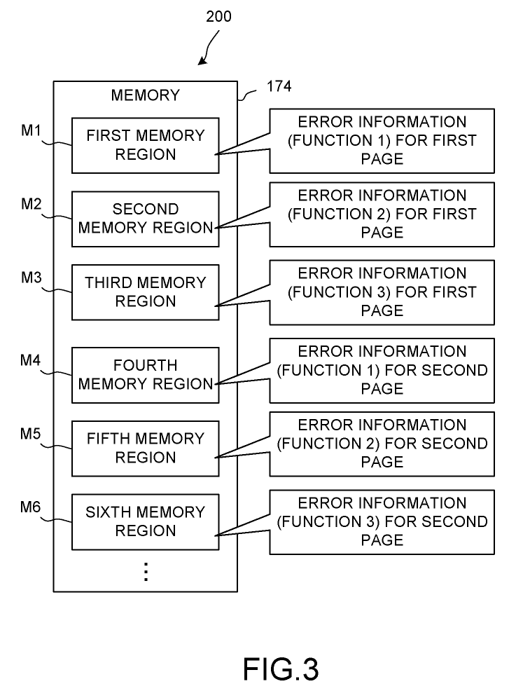

The problem mentioned above will be specifically described below with reference to an image processing apparatus 200 according to a comparative example shown in FIG. 3. As shown in FIG. 3, the image processing apparatus 200 according to the comparative example is configured to store, in a plurality (six here) of memory regions (a first memory region M1 to a sixth memory region M6) included in a memory 174, pieces of error information regarding respective corresponding abnormalities.

Here, a memory region refers to any one of the regions obtained by dividing the region capable of storing information in the memory 174 into a plurality of regions. An address that the control portion 17 is cable of designating is allocated thereto. It is possible for the control portion 17 to execute, by designating an address, a process of reading data from the memory region to which the address is allocated or a process of writing data to the memory region.

In addition, FIG. 3 shows examples of pieces of error information stored in the memory 174 when an image process of consecutively reading a plurality of document sheets and forming a plurality of images read from the plurality of respective document sheets on a plurality of respective sheets is executed.

Here, "error information (function 1)" in FIG. 3 is error information regarding "function 1" among a plurality of types of abnormality detection functions of the image processing apparatus 200 according to the comparative example. This error information is expressed a unique variable corresponding to the error information. Here, "function 1" is an abnormality detection function that detects a multi-feed in which a plurality of document sheets is conveyed in an overlapped state in a reading process of reading an image from a document sheet.

In addition, "error information (function 2)" in FIG. 3 is error information regarding "function 2" among the plurality of types of abnormality detection functions of the image processing apparatus 200 according to the comparative example. This error information is expressed as a unique variable corresponding to the error information. Here, "function 2" is an abnormality detection function that detects an image defect in a reading process of reading an image from a document sheet. The image defect may occur, for example, in a case where a corner portion of a document sheet is folded when the document sheet is read. The region of the image defect in this case is the folded portion of the document sheet. In addition, the image defect may occur, for example, in a case where a slip of paper such as a label sheet other than a document sheet is pasted to a document sheet. The region of the image defect in this case is a portion to which the slip of paper is pasted.

In addition, "error information (function 3)" in FIG. 3 is error information regarding "function 3" among the plurality of types of abnormality detection functions of the image processing apparatus 200 according to the comparative example. This error information is expressed as a unique variable corresponding to the error information. Here, "function 3" is an abnormality detection function that detects a feed abnormality in which it is not possible to pick up a sheet stored in the sheet feed cassette and it is not possible to feed a sheet to the conveyance path in a formation process of forming an image on a sheet.

Specifically, error information regarding "function 1" for the first page of document sheets is stored in the first memory region M1. In addition, error information regarding "function 2" for the first page of the document sheets is stored in the second memory region M2. In addition, error information regarding "function 3" for the first page of the document sheets is stored in the third memory region M3. In this way, in the image processing apparatus 200 according to the comparative example, error information is stored in the memory region corresponding to each of the abnormality detection functions. Accordingly, the image processing apparatus 200 according to the comparative example has a problem that the usage rate of the memory 174 increases because, as the image processing apparatus 200 has more abnormality detection functions, more memory regions are required.

In addition, in the image processing apparatus 200 according to the comparative example, error information is stored in the memory region corresponding to each of the pages in addition to each of the abnormality detection functions. In the example shown in FIG. 3, error information regarding "function 1" for the second page of the document sheets is stored in the fourth memory region M4. In addition, error information regarding "function 2" for the second page of the document sheets is stored in the fifth memory region M5. In addition, error information regarding "function 3" for the second page of the document sheets is stored in the sixth memory region M6. In this way, the image processing apparatus 200 according to the comparative example has a problem that the usage rate of the memory 174 increases because, as the document sheets have more pages to be read, more memory regions are required.

In contrast, in this embodiment, a process executed by the control portion 17 of the image processing apparatus 100 described above makes it possible to implement the image processing apparatus 100 and a method for the image processing apparatus 100. The image processing apparatus 100 makes it possible to store detection results of a plurality of types of abnormalities in the memory while reducing the usage rate of the memory and a method for the image processing apparatus 100.

2. Configuration of Control Portion
Hereinafter, each of functional portions included in the control portion 17 will be described in more detail with reference to FIG. 1. The control portion 17 includes a detection processing portion 171, a memory processing portion 172, and a notification processing portion 173. That is, the image processing apparatus 100 includes the detection processing portion 171, the memory processing portion 172, and the notification processing portion 173 as functions of the control portion 17. In addition, the control portion 17 includes the memory 174.

The memory 174 is, for example, a volatile memory such as a RAM and stores data necessary to execute a program that is executed by the control portion 17. In addition, the memory 174 stores detection results of a plurality of types of abnormalities (described below) detected by the detection processing portion 171.

The detection processing portion 171 detects a plurality of types of abnormalities in an image process including at least one of a reading process of reading an image from a document sheet and a formation process of forming the image on a sheet. In this embodiment, the detection processing portion 171 detects the three types of abnormalities of the multi-feed, the image defect, and the feed error that have already been described.

It is noted that the detection processing portion 171 is not limited to the configuration in which the three types of abnormalities are detected. For example, the detection processing portion 171 may be configured to detect two types of abnormalities or may be configured to detect four or more types of abnormalities. In addition, abnormalities that are detected by the detection processing portion 171 are not limited to the multi-feed, the image defect, and the feed error described above and may include another type of abnormality.

Specifically, the detection processing portion 171 detects the presence or absence of a multi-feed using a multi-feed sensor (not illustrated) of the image reading portion 12. The multi-feed sensor is, for example, an ultrasonic sensor and outputs an ultrasonic wave from the output surface of the ultrasonic sensor. In addition, the multi-feed sensor receives a reflected wave that is reflected by a document sheet and outputs a signal indicating the intensity of the reflected wave when the document sheet passes through a position opposed to the output surface. The detection processing portion 171 then detects the presence or absence of a multi-feed by comparing the intensity of the reflected wave indicated by the signal with the intensity (reference intensity) of the reflected wave obtained when one document sheet passes through the position described above. That is, the detection processing portion 171 detects the occurrence of a multi-feed in a case where the intensity of the reflected wave indicated by the signal is less than the reference intensity, that is, in a case where the ultrasonic wave is attenuated more. It is noted that the multi-feed sensor is not limited to an ultrasonic sensor and may be, for example, a light sensor.

In addition, the detection processing portion 171 detects the presence or absence of an image defect using an image recognition model (not illustrated) subjected to machine learning in advance. The image recognition model is generated, for example, by machine learning performed using a training data set including a large number of pieces of supervised data. Each of the pieces of supervised data includes sample image data and ground-truth data indicating the presence or absence of an image defect. It is noted that the detection processing portion 171 may detect the presence or absence of an image defect, for example, by identifying an image defect region through an image recognition process such as edge detection without using the image recognition model.

In addition, the detection processing portion 171 detects the presence or absence of a feed error using a light sensor (not illustrated) disposed in the conveyance path. The light sensor detects the front end or the rear end of a sheet passing through the conveyance path. The detection processing portion 171 then detects the occurrence of a feed error in a case where the light sensor does not detect the front end of the first sheet even a predetermined time after the start of an image process. In addition, the detection processing portion 171 detects the occurrence of a feed error in a case where, even a predetermined time after the light sensor detects the rear end of a sheet, the light sensor does not detect the front end of the next sheet when images are consecutively formed on a plurality of sheets. It is noted that a line sensor may be used instead of the light sensor.

The memory processing portion 172 stores detection results of a plurality of types of abnormalities by the detection processing portion 171 in the memory 174 as one variable. That is, unlike the image processing apparatus 200 according to the comparative example, pieces of error information are not each expressed as a unique variable corresponding to each of the types of abnormalities, but are collectively expressed as one common variable regardless of the types of abnormalities in this embodiment. This makes it possible to reduce the usage rate of the memory 174 because less memory regions are required in comparison with the storage of error information in the corresponding memory region for each of variables. The image processing apparatus 100 according to this embodiment thus makes it possible to store detection results of a plurality of types of abnormalities in the memory 174 while reducing the usage rate of the memory 174.

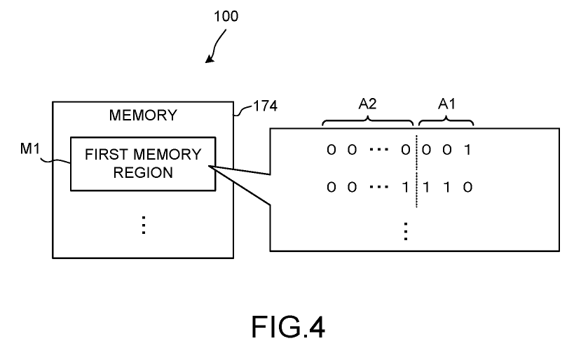

In addition, in this embodiment, the one variable is expressed as a multi-digit bit string as shown in FIG. 4. In other words, the one variable includes a plurality of values (bits) expressed in one dimension. The detection results of the plurality of types of abnormalities are then assigned to the plurality of respective values to avoid overlap. This allows the control portion 17 to determine which of the plurality of types of abnormalities is detected by referring to the plurality of values included in the one variable. It is noted that the one variable only has to include a plurality of values expressed in one dimension. For example, the one variable may be thus expressed by another base-N system (N is a natural number) such as a decimal system instead of a binary system.

In addition, in this embodiment, the memory processing portion 172 stores one variable in one memory region in the memory 174 as shown in FIG. 4. Specifically, the memory processing portion 172 stores the one variable in the first memory region M1 of a plurality of memory regions in the memory 174. This makes it possible to reduce the usage rate of usage of the memory 174 because less memory regions are required in comparison with the separate storage of detection results of a plurality of types of abnormalities in a plurality of memory regions. It is noted that the memory region in which the one variable is stored is not limited to the first memory region M1. The one variable may be stored in another memory region.

In addition, in this embodiment, in a case where the image process is consecutively performed for a plurality of the sheets or a plurality of the document sheets, the memory processing portion 172 stores the detection results of the plurality of respective sheets or the plurality of respective document sheets in the memory 174 as one variable. That is, in this embodiment, unlike the image processing apparatus 200 according to the comparative example, pieces of error information are not stored in the corresponding memory regions for the respective pages, but the pieces of error information are collectively stored in the same memory region (the first memory region M1 here). This makes it possible to reduce the usage rate of the memory 174 because less memory regions are required in comparison with the storage of error information in the corresponding memory region for each of pages.

Specifically, in this embodiment, as shown in FIG. 4, a first bit group A1 including a plurality of lower-order digits (three digits here) of a bit string serving as one variable indicates detection results of a plurality of types of abnormalities. Here, the least significant bit in the first bit group A1 indicates a detection result of "function 1" (that is, a multi-feed) and the second least significant bit indicates a detection result of "function 2" (that is, an image defect). In addition, the third least significant bit in the first bit group A1 indicates a detection result of "function 3" (that is, a feed error). In each of the bits, "0" indicates the occurrence of no abnormality and "1" indicates the occurrence of an abnormality.

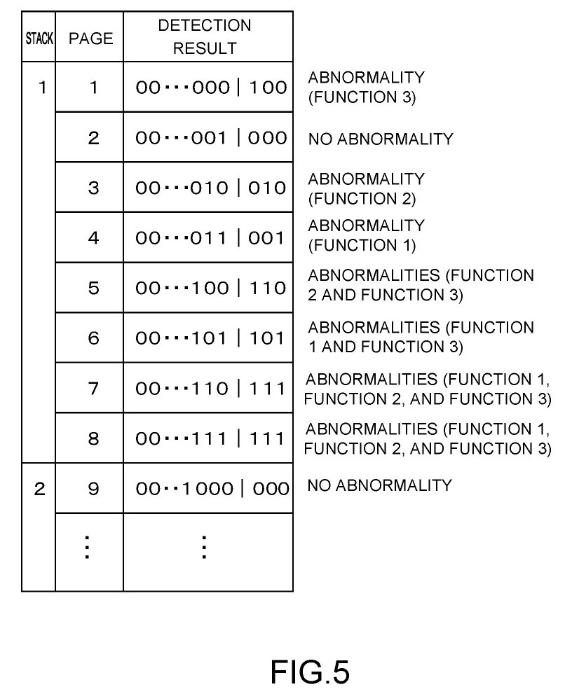

A specific example of the first bit group A1 will be described below with reference to FIG. 5. In FIG. 5, "stack" represents the ordinal number of stacks in a case where the image reading portion 12 reads a plurality of document sheets as one stack. "Stack" will be described below. In addition, in FIG. 5, "page" represents the ordinal number of document sheets in a case where the image reading portion 12 reads a plurality of document sheets. In addition, in FIG. 5, "detection result" represents one variable (a bit string here) stored in the memory 174. The lower three digits of a bit string indicate the first bit group A1 and the plurality of remaining upper digits indicates a second bit group A2 (described below).

As shown in "detection result" of FIG. 5, a bit string in which the first bit group A1 is "000" indicates the occurrence of no abnormality and a bit string in which the first bit group A1 is "001" indicates the occurrence of an abnormality in "function 1". In addition, a bit string in which the first bit group A1 is "010" indicates the occurrence of an abnormality in "function 2" and a bit string in which the first bit group A1 is "100" indicates the occurrence of an abnormality in "function 3".

Furthermore, it is also possible for the first bit group A1 to express the occurrence of two or more types of abnormalities. Specifically, a bit string in which the first bit group A1 is "011" indicates the concurrent occurrence of abnormalities in "function 1" and "function 2" and a bit string in which the first bit group A1 is "101" indicates the concurrent occurrence of abnormalities in "function 1" and "function 3". In addition, a bit string in which the first bit group A1 is "110" indicates the concurrent occurrence of abnormalities in "function 2" and "function 3" and a bit string in which the first bit group A1 is "111" indicates the concurrent occurrence of abnormalities in all the functions.

In addition, in this embodiment, the second bit group A2 including a plurality of higher-order digits (n (n is a natural number of 2 or more) digits here) of a bit string serving as one variable indicates the page number of a document sheet in a case where a plurality of document sheets is consecutively read. In the example shown in FIG. 5, a bit string in which the second bit group A2 is "00...0" indicates error information for the first page of the document sheets and a bit string in which the second bit group A2 is "00...1" indicates error information for the second page of the document sheets. That is, the second bit group A2 indicates the page number in a binary system using "00...0" for the first page of the document sheets.

Incidentally, in a case where there are a large number of document sheets, the document sheets are divided into a plurality of stacks and an image process is then executed in some cases. For example, in a case where the document sheets are divided into two stacks and an image process is executed, a user first places the first stack of document sheets on the document sheet set portion of the ADF 11 and causes the image reading portion 12 to execute a reading process for the first stack of document sheets. When the reading process for the first stack of document sheets is completed, the user then places the second stack of document sheets on the document sheet set portion of the ADF 11 and causes the image reading portion 12 to execute a reading process for the second stack of document sheets. When the reading process for all of the document sheets is completed, the user then performs an operation for starting a formation process using the operation portion 16. This allows the image forming portion 13 to execute a formation process for all of the read document sheets.

In the case described above, it is possible for the memory processing portion 172 to cause the memory 174 to store pieces of error information for all the document sheets as one variable without separating error information for the first stack of document sheets and error information for the second stack of document sheets. That is, in a case where a first image process is completed and a second image process is then executed as an image process, the memory processing portion 172 executes the following process. The first image process is an image process for a first group including a plurality of sheets or a plurality of document sheets. The second image process is an image process for a second group including a plurality of other sheets or a plurality of other document sheets. Here, the first group corresponds to the first stack of document sheets and the second group corresponds to the second stack of document sheets. This process is a process of further storing detection results for a plurality of other respective sheets or a plurality of other respective document sheets in the second image process in the memory 174 as one variable. This makes it possible to reduce the usage rate of usage of the memory 174 because less memory regions are required in comparison with the separate storage of a plurality of stacks of document sheets in a plurality of memory regions.

Hereinafter, a specific example of the process described above will be described with reference to FIG. 5. In the example shown in FIG. 5, the first stack of document sheets includes eight document sheets in total from the first page to the eighth page and the second stack of document sheets includes the document sheets of the ninth and subsequent pages. In this case, the memory processing portion 172 does not distinguish the second stack of document sheets from the first stack of document sheets and collectively performs the process as a plurality of document sheets. Here, the memory processing portion 172 regards the second stack of document sheets as the ninth and subsequent pages of the document sheets and causes the memory 174 to store the pieces of error information for the respective pages as one variable. Specifically, the memory processing portion 172 sets the second bit group A2 to "00...1000" in the bit string corresponding to the first page of the second stack of document sheets. That is, the memory processing portion 172 processes the first page of the second stack of document sheets as a consecutive page (ninth page) following the last page (eighth page) of the first stack of document sheets.

In a case where an image process for the plurality of sheets or the plurality of document sheets is completed, the notification processing portion 173 issues a notification of a detection result of each of the plurality of sheets or each of the plurality of document sheets stored in the memory 174. Specifically, the notification processing portion 173 causes the display portion 15 to display, for example, whether or not an abnormality occurs in each sheet and display a character string, an image, or the like indicating the type of abnormality in a case where any abnormality occurs. This allows a user to grasp, for example, whether or not the image process is performed normally or what kind of abnormality occurs in the middle of the image process.

It is noted that the notification processing portion 173 does not have to issue a notification in a case where no abnormality occurs in the middle of the image process. In addition, the notification processing portion 173 may issue a notification in a case where an abnormality occurs in the middle of the image process in addition to issuing a notification at the time of completion of the image process. In addition, in a case where the image processing apparatus 100 includes a speaker, the notification processing portion 173 may issue a notification by causing the speaker to output sound.

Incidentally, it is necessary to cause the memory 174 to hold error information in a case where a user is notified of pieces of error information for a plurality of document sheets collectively at the timing of completion of an image process for the respective document sheets. Meanwhile, in a case where an abnormality occurs in the middle of an image process, a user is notified of error information each time in some cases. In the latter case, it is not necessary to cause the memory 174 to hold error information.

Here, it is possible in some cases to make settings for each of the types of abnormalities as to whether the image processing apparatus 100 issues a notification in accordance with the former case or issues a notification in accordance with the latter case. In this case, it is also possible for the memory processing portion 172 to hold only the error information a notification of which is issued in accordance with the former case in the memory 174 and avoid holding the error information a notification of which is issued in accordance with the latter case in the memory 174.

That is, in a case where the notification processing portion 173 executes any one of the first notification process and the second notification process, the memory processing portion 172 executes the following process. This process is a process of storing a detection result of the type of abnormality that is a target for the second notification process in the memory 174 without storing a detection result of the type of abnormality that is a target for the first notification process in the memory 174. Here, the first notification process is a process of issuing a notification for each of a plurality of types of abnormalities whenever the detection processing portion 171 detects an abnormality. The second notification process is a process of issuing a notification for each of a plurality of types of abnormality when the reading of a plurality of document sheets is completed in a reading process. This prevents the memory 174 from storing error information that does not have to be held and it is thus possible to reduce the usage rate of the memory 174.

Specifically, it is assumed that settings are made to issue a notification of the error information about each of "function 1" and "function 2" whenever an abnormality occurs and issue a notification of the error information about "function 3" at the timing of completion of the image process. In this case, the memory processing portion 172 causes the memory 174 to store only one variable (a bit string here) indicating the occurrence of an abnormality in "function 3". Additionally, in a case where an abnormality also occurs in "function 1" or "function 2" at the same time in addition to the abnormality in "function 3", the memory processing portion 172 causes the memory 174 to store one variable indicating the occurrence of these abnormalities.

In addition, in a case where the settings of executing any one of the first notification process and the second notification process for any type of abnormality among the plurality of types of abnormalities are switched to the settings of executing the other of the first notification process and the second notification process in the middle of the image process, the memory processing portion 172 may execute the following process. The process is a process of selecting for the type of abnormality whether or not perform storage in the memory 174 in accordance with the switched settings. A situation in which the settings are switched as described above may occur, for example, at the timing of placing the second stack of document sheets on the document sheet set portion of the ADF 11, the timing of the occurrence of a jam, the timing of checking an abnormality that occurs by a user, or the like.

Specifically, it is assumed that settings are made to issue a notification of the error information about each of "function 1" and "function 2" whenever an abnormality occurs and issue a notification of the error information about "function 3" at the timing of completion of the image process. It is then assumed that the settings are switched in the middle of the image process such that a notification is issued whenever an abnormality occurs in the error information about "function 3". In this case, the memory processing portion 172 selects whether to continuously store the error information about "function 3" in the memory 174 after the settings are switched or avoid storing the error information about "function 3" in the memory 174. It is noted that the memory processing portion 172 may ask the user about the selection described above using the notification processing portion 173. In this case, the memory processing portion 172 determines how to handle the error information about "function 3" in accordance with the selection by the user.

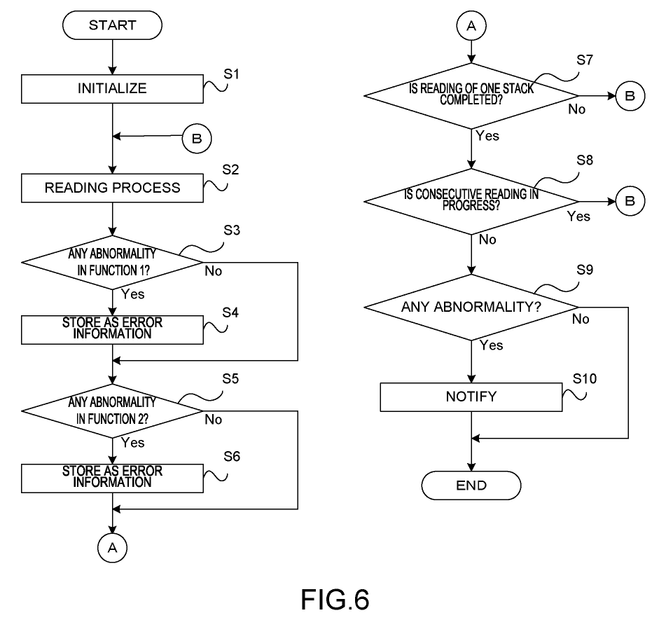

3. Operation Example of Image Processing Apparatus
Hereinafter, an example of the method for controlling the image processing apparatus 100 according to this embodiment will be described with reference to FIG. 6 along with examples of procedures of a process that is executed by the image processing apparatus 100. Here, steps S1, S2, ... denote the numbers of processing procedures (steps) that are executed by the image processing apparatus 100. This process is started, for example, by the operation portion 16 receiving an operation by a user for starting an image process. In addition, it is assumed here that the detection processing portion 171 detects an abnormality in "function 1" and an abnormality in "function 2" among a plurality of types of abnormalities.

<Step S1>
First, the control portion 17 of the image processing apparatus 100 initializes a memory region (the first memory region M1 here) in which error information is stored in the memory 174, for example, by deleting the error information stored in the memory 174.

<Step S2>
Next, the control portion 17 executes a reading process. In the reading process, a document sheet is conveyed by the ADF 11 and an image is read from the document sheet by the image reading portion 12.

<Step S3>
The detection processing portion 171 of the image processing apparatus 100 detects whether or not an abnormality occurs in "function 1". In a case where an abnormality occurs in "function 1" (step S3: Yes), the memory processing portion 172 executes step S4. In contrast, in a case where no abnormality occurs in "function 1" (step S3: No), the detection processing portion 171 executes step S5.

<Step S4>
The memory processing portion 172 stores error information about "function 1" in the memory 174. Specifically, the memory processing portion 172 sets the bit corresponding to the error information about "function 1" to "1" in one variable (a bit string here) corresponding to the read document sheet for storage in the memory 174.

<Step S5>
The detection processing portion 171 detects whether or not an abnormality occurs in "function 2". In a case where an abnormality occurs in "function 2" (step S5: Yes), the memory processing portion 172 executes step S6. In contrast, in a case where no abnormality occurs in "function 2" (step S5: No), the detection processing portion 171 executes step S7 (see "A" in FIG. 6).

<Step S6>
The memory processing portion 172 stores error information about "function 2" in the memory 174. Specifically, the memory processing portion 172 sets the bit corresponding to the error information about "function 2" to "1" in one variable (a bit string here) corresponding to the read document sheet for storage in the memory 174.

<Step S7>
The control portion 17 determines whether or not the reading of all document sheets in one stack of document sheets placed on the document sheet set portion of the ADF 11 is completed. In a case where the reading has not yet been completed (step S7: No), the control portion 17 executes the processes of steps S2 to S6 for the next document sheet (see "B" in FIG. 6). In contrast, in a case where the reading is completed (step S7: Yes), the control portion 17 executes step S8.

<Step S8>
The control portion 17 determines whether or not consecutive reading is in progress, that is, whether or not there is still a stack of document sheets. In a case where consecutive reading is in progress, that is, in a case where a user has not yet performed an operation for starting a formation process (step S8: Yes), the control portion 17 executes the processes of steps S2 to S6 for the next document sheet (see "B" in FIG. 6). In contrast, in a case where consecutive reading is completed, that is, in a case where a user performs an operation for starting a formation process (step S8: No), the control portion 17 executes step S9.

<Step S9>
The control portion 17 reads the error information stored in the memory 174 (the first memory region M1 here) and determines whether or not an abnormality is detected in the reading process. In a case where an abnormality is detected, that is, in a case where any of the bits of the first bit group A1 is "1" in any one variable (step S9: Yes), the control portion 17 executes step S10. In contrast, in a case where no abnormality is detected, that is, in a case where all of the bits of the first bit group A1 are "0" in any one variable (step S9: No), the control portion 17 brings the process to an end.

<Step S10>
The notification processing portion 173 of the image processing apparatus 100 issues notifications of detection results of a plurality of respective sheets or a plurality of respective document sheets stored in the memory 174. Here, the notification processing portion 173 issues a notification of a detection result of a document sheet in which an abnormality is detected among the plurality of document sheets on which the reading process is executed.

In addition, the procedures described above are merely examples and the order of processes shown in the flowchart of FIG. 6 may be changed as appropriate.

### Modification

In this embodiment, the plurality of components included in the image processing apparatus 100 may be distributed and provided in a plurality of housings. For example, the detection processing portion 171, the memory processing portion 172, the notification processing portion 173, and the memory 174 may be provided separately.

### Supplementary Notes of Disclosure

The gist of the disclosure extracted from the embodiment described above will be supplementarily noted below. It is noted that the respective configurations and the respective processing functions described in the following supplementary notes can be sorted out and used in any combination.

<Supplementary Note 1>
An image processing apparatus including:
   a detection processing portion configured to detect a plurality of types of abnormalities in an image process including at least one of a reading process of reading an image from a document sheet and a formation process of forming the image on a sheet; and
   a memory processing portion configured to store detection results of the plurality of types of abnormalities in a memory as one variable.

<Supplementary Note 2>
The image processing apparatus according to Supplementary Note 1, in which
   the one variable includes a plurality of values expressed in one dimension, and
   the detection results of the plurality of types of abnormalities are assigned to the plurality of respective values to avoid overlap.

<Supplementary Note 3>
The image processing apparatus according to Supplementary Note 1 or 2, in which the memory processing portion stores the one variable in one memory region in the memory.

<Supplementary Note 4>
The image processing apparatus according to any one of Supplementary Notes 1 to 3, in which, in a case where the image process is consecutively performed for a plurality of the sheets or a plurality of the document sheets, the memory processing portion stores the detection results of a plurality of the respective sheets or a plurality of the respective document sheets in the memory as the one variable.

<Supplementary Note 5>
The image processing apparatus according to Supplementary Note 4, further including a notification processing portion configured to issue notifications of the detection results of a plurality of the respective sheets or a plurality of the respective document sheets stored in the memory in a case where the image process is completed for a plurality of the sheets or a plurality of the document sheets.

<Supplementary Note 6>
The image processing apparatus according to Supplementary Note 4 or 5, in which, in a case where a first image process for a first group including a plurality of the sheets or a plurality of the document sheets is completed and a second image process for a second group including a plurality of the other sheets or a plurality of the other document sheets is then executed as the image process, the memory processing portion further stores the detection results of a plurality of the other respective sheets or a plurality of the other respective document sheets in the second image process in the memory as the one variable.

<Supplementary Note 7>
The image processing apparatus according to Supplementary Note 5, in which the notification processing portion executes any one of a first notification process and a second notification process for each of the plurality of types of abnormalities, the first notification process being for issuing a notification whenever the detection processing portion detects an abnormality, the second notification process being for issuing a notification when reading of a plurality of the document sheets is completed in the reading process, and
the memory processing portion does not store a detection result of a type of abnormality that is a target for the first notification process in the memory, but stores a detection result of a type of abnormality that is a target for the second notification process in the memory.

<Supplementary Note 8>
The image processing apparatus according to Supplementary Note 7, in which, in a case where a setting of executing any one of the first notification process and the second notification process for any type of abnormality among the plurality of types of abnormalities is switched to a setting of executing another of the first notification process and the second notification process in a middle of the image process, the memory processing portion selects for the type of abnormality whether or not to perform storage in the memory in accordance with the switched setting.

<Supplementary Note 9>
A method for controlling an image processing apparatus, the method including:
detecting a plurality of types of abnormalities in an image process including at least one of a reading process of reading an image from a document sheet and a formation process of forming the image on a sheet; and
storing detection results of the plurality of types of abnormalities in a memory as one variable.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image processing apparatus comprising:
a detection processing portion configured to detect a plurality of types of abnormalities in an image process including at least one of a reading process of reading an image from a document sheet and a formation process of forming the image on a sheet; and
a memory processing portion configured to store detection results of the plurality of types of abnormalities in a memory as one variable.

2. The image processing apparatus according to claim 1, wherein
the one variable includes a plurality of values expressed in one dimension, and
the detection results of the plurality of types of abnormalities are assigned to the plurality of respective values to avoid overlap.

3. The image processing apparatus according to claim 1, wherein the memory processing portion stores the one variable in one memory region in the memory.

4. The image processing apparatus according to claim 1, wherein, in a case where the image process is consecutively performed for a plurality of the sheets or a plurality of the document sheets, the memory processing portion stores the detection results of a plurality of the respective sheets or a plurality of the respective document sheets in the memory as the one variable.

5. The image processing apparatus according to claim 4, further comprising a notification processing portion configured to issue notifications of the detection results of a plurality of the respective sheets or a plurality of the respective document sheets stored in the memory in a case where the image process is completed for a plurality of the sheets or a plurality of the document sheets.

6. The image processing apparatus according to claim 4, wherein, in a case where a first image process for a first group including a plurality of the sheets or a plurality of the document sheets is completed and a second image process for a second group including a plurality of the other sheets or a plurality of the other document sheets is then executed as the image process, the memory processing portion further stores the detection results of a plurality of the other respective sheets or a plurality of the other respective document sheets in the second image process in the memory as the one variable.

7. The image processing apparatus according to claim 5, wherein
the notification processing portion executes any one of a first notification process and a second notification process for each of the plurality of types of abnormalities, the first notification process being for issuing a notification whenever the detection processing portion detects an abnormality, the second notification process being for issuing a notification when reading of a plurality of the document sheets is completed in the reading process, and
the memory processing portion does not store a detection result of a type of abnormality that is a target for the first notification process in the memory, but stores a detection result of a type of abnormality that is a target for the second notification process in the memory.

8. The image processing apparatus according to claim 7, wherein, in a case where a setting of executing any one of the first notification process and the second notification process for any type of abnormality among the plurality of types of abnormalities is switched to a setting of executing another of the first notification process and the second notification process in a middle of the image process, the memory processing portion selects for the type of abnormality whether or not to perform storage in the memory in accordance with the switched setting.

9. A method for controlling an image processing apparatus, the method comprising:
detecting a plurality of types of abnormalities in an image process including at least one of a reading process of reading an image from a document sheet and a formation process of forming the image on a sheet; and
storing detection results of the plurality of types of abnormalities in a memory as one variable.
